(19) United States
(12) Patent Application Publication
(10) Pub. No.: US 2026/0250182 A1
(43) Pub. Date: Aug. 27, 2026

(54) ENAMEL PASTE, METHOD OF FORMING AN ENAMEL COATING, ENAMEL COATED SUBSTRATE AND USE THEREOF

(71) Applicant: Fenzi AGT Netherlands B.V., Maastricht (NL)

(72) Inventors: Roland KATZBACH, Maastricht (NL); Rob BERGHMANS, Maastricht (NL); Simon BARTOLOMEY, Maastricht (NL); Akira MASUTANI, Maastricht (NL)

(21) Appl. No.: 19/159,217

(22) PCT Filed: Feb. 21, 2024
(86) PCT No.: PCT/NL2024/050085

§ 371 Date: Aug. 22, 2025

(30) Foreign Application Priority Data
Feb. 22, 2023 (NL) 2034204

(51) Int. Cl. C03C 8/04; C03C 8/14; C03C 17/04

(52) U.S. Cl. CPC C03C 8/04; C03C 8/14; C03C 17/04; C03C 2217/72

(57) ABSTRACT

The present disclosure relates to an enamel paste, a method of forming an enamel coating with the enamel paste, an enamel coated substrate obtainable or obtained by the method and the use of the enamel coated substrate as a decorative and/or functional article in automotive, marine, aerospace, home appliance, lab and tableware, pharmaceutical packaging, architecture, and information technology.

The present invention relates to an enamel paste, a method of forming an enamel coating with said enamel paste, an enamel coated substrate obtainable or obtained by said method and the use of said enamel coated substrate as a decorative article.

### INTRODUCTION

The decoration of articles with enamels requires a matching of the coefficient of thermal expansion (CTE) which is typically equal or smaller than that of the substrate. If differences in thermal expansion between the substrate of the article and the enamel are too high, stresses build up due to the different thermal expansion of substrate and enamel. If the CTE of an enamel is too high compared to that of the substrate, this may result in the formation of microcracks which adversely affects mechanical properties and the thermal shock resistance of the decorated article.

This forms in particular a challenge with low CTE substrate materials such as glasses, glass-ceramics and ceramics of families of the borosilicate, boroaluminosilicate or alumosilicate glasses, glass-ceramic such as lithium aluminosilicate system (LAS) glass-ceramics, or ceramics such as sapphire, cordierite, mullite, or technical porcelain, which have typical technical CTEs ranging between 2 to 6×10⁻⁶ K⁻¹.

The present invention addresses the challenge of substrate materials with a low thermal expansion such as below 6×10⁻⁶ K⁻¹ or at least below that of conventional window glass.

### SUMMARY OF THE INVENTION

The invention relates in a first aspect to an enamel paste comprising: a first material selected from particles of glass, ceramic or glass-ceramic particles; a second material selected from particles of glass, ceramic or glass-ceramic particles; and an organic carrier medium; wherein the first material has a first coefficient of thermal expansion (CTE1), a first particle size D90 and a first transition temperature (T1) and wherein said second material has a second coefficient of thermal expansion (CTE2), a second particle size D90 and a second transition temperature (T2); wherein CTE1<CTE2; and T1>T2; and wherein the first material has a particle size D90 of >2× the particle size D90 of the second material.

In a second aspect the invention relates to a method of forming an enamel coating, comprising i) depositing the enamel paste composition according to any of the previous claims on a substrate with a third coefficient of thermal expansion (CTE3); and ii) firing the enamel paste to form an enamel coating on the substrate, the enamel coating comprising a heterogeneous microstructure with particles of the first material embedded in a matrix comprising said second material; and wherein after depositing and firing the enamel has a composite coefficient of thermal expansion (CTE-COMP), wherein CTE-COMP≤CTE3.

In a third aspect the invention relates to an enamel coated substrate obtainable or obtained by the method of the second aspect.

In a fourth aspect the invention relates to the use of the enamel coated substrate of the third aspect as a decorative and/or functional article in automotive, marine, aerospace, home appliance, lab and tableware, pharmaceutical packaging, architecture, and information technology.

### DETAILED DESCRIPTION OF THE INVENTION

In accordance with the present invention an enamel paste is provided which comprises a first material selected from particles of glass, ceramic or glass-ceramic particles; a second material selected from particles of glass, ceramic or glass-ceramic particles; and an organic carrier medium; wherein the first material has a first coefficient of thermal expansion (CTE1), a first particle size D90 and a first transition temperature (T1) and wherein said second material has a second coefficient of thermal expansion (CTE2), a second particle size D90 and a second transition temperature (T2); wherein CTE1<CTE2; and T1>T2; and wherein the first material has a particle size D90 of more than two times the particle size D90 of the second material.

In the context of the invention, thermal expansion in the term CTE normally refers to a material's increase in size with increasing temperature. While materials normally have a positive coefficient of thermal expansion, it is also possible (as evidenced in the examples below) that the first material has such a low CTE, that the CTE is negative. Such negative thermal expansion is an unusual physicochemical process in which some materials contract upon heating, rather than expand as most other materials do.

The first material typically has a low CTE which is chosen to be lower than the CTE of the substrate to be coated. As such, the first material functions as a CTE modifier phase, allowing to achieve a very low overall CTE of the enamel that matches the CTE of a low CTE substrate. On the other hand, due to its lower transition temperature the second material in the matrix phase ensures adhesion to the substrate and cohesion of the components within the enamel. The low-CTE enamels in accordance with the invention are therefore very suitable for the application on low-CTE substrates. The use of the enamels reduces glass weakening and opens up the opportunity of high-impact resistant automotive glazing, thus improving passenger and traffic safety. Additionally, it allows for lighter weight glazing products, for instance of borosilicate glass, such as automotive glazing products, including windshields, over side windows, rear windows, quarter glass, sunroof glass, backlight glass and door glass, which help to reduce fuel consumption while travelling.

When an enamel paste in accordance with the invention is deposited and fired, the second material frit is sintered around the particles of the first material. A characteristic of the enamels of the present invention is that the materials do not fuse into homogeneous regions within the enamel coating on firing but rather provide a coherent heterogeneous frit micro-structure comprising two entangled, percolating 3-dimensional (3D) networks of functional particles of the first material (“bricks”) and particles of the second material (“mortar”). As such, the enamel microstructure after firing is reminiscent of a brick-sand-mortar structure with the first material forming the “bricks” and the second material having been sintered to form a matrix or the “mortar”.

The first and second materials have different transition temperatures, wherein the transition temperature of the first material is higher than that of the second material. The term “transition temperature” in the context indicates the temperature at which a sudden change of physical properties occurs, such as a change of phase or crystalline structure. The term “glass transition temperature” applies to glasses and glass-ceramics, or the residual glass phase of the glass ceramics, to be precise. It is the temperature at which an amorphous material transitions from the solid state to the undercooled melt (or vice versa, depending on whether heating or cooling takes place). That transition also changes the macroscopic behavior of the material and it changes from solid-like behavior to liquid-like behavior, including but not limited to transitioning from elasticity to viscous flow. The glass transition temperature is representative for a temperature range, because the transition happens gradually. Experimentally, it is determined with a differential scanning calorimeter at a standardized heating rate of 10 K/min. The commonly used symbol is T_{g}. A ceramic material in principle does not exhibit a glass transition temperature, so for these materials the term liquidus temperature may be used to specify the transition temperature in analogy to the glass transition temperature.

The first and second materials may be selected from particles of glass, ceramic or glass-ceramic particles with the first (brick) material having a higher transition temperature and lower CTE than that of the second (mortar) material. The first material can be selected by type and quantity to tailor the thermal expansion of the enamel to match the substrate. In one embodiment the first material is formed of glass particles. In another embodiment the first material is formed of glass-ceramic particles. In another embodiment the first material is formed of ceramic particles. Ceramics are crystalline, while glasses are amorphous. Glass-ceramics are a combination of a crystalline phase and an amorphous glass phase. They contain at least one type of functional crystalline phase and a residual glass phase.

Ceramics usually exhibit high transition temperatures, while in the context of the invention many useful glass species may exhibit a transition temperature that is lower. In this respect, if the first material is a ceramic, it may be preferred that the second material is a glass-ceramic or glass material, preferably a glass frit. In line with this, if the first material is a glass-ceramic, the second material may suitably be a glass material. It is also possible that the first and second material are both glasses or both glass-ceramics, albeit with different CTEs and transition temperatures, in accordance with the requirements specified above.

The present invention addresses the challenge of substrate materials with a low thermal expansion below 6×10⁻⁶ K⁻¹ (6 ppm/K) or at least below that of conventional window glass. The CTE in the context of the invention refers to the CTE in the temperature range between 25-300° C.

The CTE of the final enamel depends on the type and quantity of components and their individual properties. The overall enamel CTE

$${α}_{V}^{*}$$

before firing can be calculated in advance according to the following equation with ξᵢ being the volume fraction of phase i, αᵢ being the CTE of the pure phase i:

$${α}_{V}^{*} = {\sum }_{i} {ξ}_{i} \cdot {α}_{i}$$

The enamel CTE can be designed on the basis of the CTE of the substrate (referred herein as CTE3). In that respect the overall enamel CTE after firing (referred herein as enamel CTE-COMP) should match or be lower than the CTE of the substrate, i.e. CTE-COMP≤CTE3. Herein it is to be understood that in general (depending on any other CTE modifying additives in the enamel) the CTE of the first material is lower than the CTE of the substrate (i.e. CTE1<CTE3). On the other hand, the present invention allows to use a second material with CTE significantly higher than the CTE of the substrate (i.e. CTE2>CTE3), broadening the scope of choice of suitable materials for the low CTE enamels of the invention. In other words, by the present invention, one is not limited to the use of low CTE materials, thus allowing to include high and low CTE materials in the enamel that may have advantageous properties that are desired for the intended application. In view of the above, a suitable CTE3 may be <6×10⁻⁶ K⁻¹, typically between 2 and 6×10⁻⁶ K⁻¹, or at least below that of conventional window glass. A suitable CTE2 of the second material may be between 2 and 6×10⁻⁶ K⁻¹ or higher, while the CTE1 of the first material is much lower, for instance between −3−2×10⁻⁶ K⁻¹, preferably between −2−1.5×10⁻⁶ K⁻¹, even more preferably between −1.5−1.0×10⁻⁶ K⁻¹ in the temperature range between 25-300° C. Within these ranges, the CTE1 may for instance be between 0-2×10⁻⁶ K⁻¹, preferably between 0−1.5×10⁻⁶ K⁻¹, even more preferably between 0.05-1.0×10⁻⁶ K⁻¹ in the temperature range between 25-300° C.

In a suitable embodiment CTE1<8×10⁻⁶ K⁻¹. In a particularly suitable embodiment CTE1 is between −3 and 4.5×10⁻⁶ K⁻¹. It may well possible that CTE1 is a negative CTE.

In a suitable embodiment CTE2<10×10⁻⁶ K⁻¹. In a particularly suitable embodiment CTE2 is between 6 and 9×10⁻⁶ K⁻¹. In the context of the application the values of CTE1, CTE2, and CTE3 relate to the CTE values before firing the enamel. The CTE1, CTE2 or CTE3 or any properties of the individual components might change after thermal treatment (firing process).

Regarding the selection of the first and second material it is also noted that in case the first material is a ceramic the transition temperature of the first material should normally be higher than that of the second material, but also higher than the firing temperature. Suitable transition temperatures of the first ceramic material T1 in this respect may be >800° C., or T1>900° C., or T1>1000°. On the other hand, for first materials that are glasses, the transition temperature can be below or at the firing temperature. If that is the case, typically their viscosity level at those temperatures is so high that the particles shape remains largely the same after firing. In view of this the brick phases in the enamel fuse barely or not at all with particles of the same kind (i.e. there is minimal “brick-to-brick contact”). During firing temperatures, materials in the brick phase have a higher viscosity than the mortar phase at relevant firing temperatures, while materials in the brick phase remain solid, or without exhibiting apparent viscous flow.

Most ceramic materials comply with w these requirements. As such, a ceramic material may be very suitable as a first material in the context of the invention. There is no particular limitation to the solidus temperature of the first material because the present invention also envisages the use of infiltrated ceramics or liquid phase sintered materials.

In the context of the invention a brick particle itself normally is isotropic although its structure could have anisotropic constitutional phases. In this regard, it may also be possible that the brick particle material is anisotropic.

The first material may comprise one type of particles or multiple types of particles, for instance differing in composition. A suitable first material for forming the bricks may be selected from the group of an oxide material, aluminosilicate, fused silica, (glass) ceramics from the LAS-system including β-eucryptite glass ceramics, β-spodumene solid solution ceramics, ceramic components of the pseudo-brookite type, cordierite, perovskite type material, and magnesium pyrophosphate, low CTE glass frit, or a mixture of these or other materials that meet the requirements of the first material as set out above.

The first material is preferably an oxide material (in contrast to nitrides, carbides, borides, and other non-oxidic materials). Oxide materials ensure compatibility and the ability to form bonds with the mortar phase which is important for the cohesion of the enamel, where non-oxidic bricks may act differently, potentially leading to defects. Oxide materials may include sulphided zinc frits. It is understood by those skilled in the art that oxide materials are meant to refer to an overarching group of materials and not refer to a specific preference or prevalence of the oxidized form of polyvalent ions, if they are part of the composition. For example, a sulphided zinc silicate frit is an oxide material, but the internal redox state shows a prevalence of polyvalent ions in the reduced state, such as sulfides rather than sulfates. In another example, an iron bearing oxide glass could have a prevalence of FeO rather than Fe₂O₃. Suitable oxide materials in the scope of the present invention thus encompass all materials belonging to that group regardless of their individual redox state, if their CTE is low enough to efficiently fulfil its purpose as CTE modifier of the enamel. In the compositions described herein, amounts of components are given as weight percentages. These weight percentages are with respect to the total weight of the composition or material. The weight percentages of oxides are the percentages of the components used as starting materials in preparation of the materials, such as the glass frit compositions mentioned above, on an oxide basis. As the skilled person will understand, starting materials other than oxides of a specific element may be used in preparing the materials, such as frits, in the context of the present invention. Where a non-oxide starting material is used to supply an oxide of a particular element to the composition, an appropriate amount of starting material may be used to supply an equivalent molar quantity of the element had the oxide of that element been supplied at the recited wt. %. This approach to defining compositions of this kind is typical in the art. As the skilled person will readily understand, volatile species (such as oxygen) may be lost during the manufacturing process of the material, and so the resulting material may not correspond exactly to the weight percentages of starting materials, which are given herein on an oxide basis. Analysis of a fired material by a process known to those skilled in the art, such as Inductively Coupled Plasma Emission Spectroscopy (ICP-ES), can for instance be used to calculate the starting components of the initial composition in question.

Suitable first materials may include bismuth and boron free frits. Such materials typically have a low CTE. Suitable first materials also include glass frits, glass-ceramics or ceramics with high silica and/or alumina content which have been found to be beneficial to achieve low CTE values. Suitable first materials in this respect may comprise >30 wt. % SiO₂, preferably >40 wt. % SiO₂, or >50 wt. % SiO₂, preferably >60 wt. % SiO₂, or even a higher wt. of SiO₂, or even consist of SiO₂, such as fused silica.

An exemplary LAS system first material may have a composition consisting of mullite, (and a solid solution of) beta-spodumene and petalite. An exemplary oxide composition of a LAS system ceramic for use as the first material may comprise 4.5-7 wt. % Li₂O, 20-32 wt. % Al₂O₃, 63-75 wt. % SiO₂, and molar ratios (Li₂O:Al₂O₃:SiO₂) of (1:1.1:6.9) to (1:1.8:5.7) resulting in a material that has a CTE between 0-2×10⁻⁶ K⁻¹, preferably between 0-1.5×10⁻⁶ K⁻¹, even more preferably between 0.05-1.0×10⁻⁶ K⁻¹ in the temperature range between 25-300° C.

Another exemplary LAS system first material may be a glass-ceramic for use as the first material and may comprise 4.0-6 wt. % Li₂O, 13-19 wt. % Al₂O₃, 25-42 wt. % SiO₂ or in other words, molar ratios (Li₂O:Al₂O₃:SiO₂) of (1:0.9:3.5) to (1:1.2:4.5) resulting in a material that has a CTE before firing between −3 (negative CTE) to 2×10⁻⁶ K⁻¹, preferably between −2.0 to 1.5×10⁻⁶ K⁻¹, even more preferably between −1.5 to 1.0×10⁻⁶ K⁻¹ in the temperature range between 25-300° C.

The second material on its turn is mainly responsible for the cohesion of the enamel, adhesion to the substrate, and to act as an embedding matrix for functional additives such as pigments and seed materials.

The first material may comprise one type of particles or multiple types of particles, for instance differing in composition.

The second material should be selected such that a dense enamel is obtained after firing. During firing sintering may occur which densifies the enamel. However, the firing process will not allow a 100% densification during typical process times and temperatures. It is therefore preferred to use amorphous materials/frits as the second material as these materials exhibit viscous flow which helps to densify the enamel without residual pores. A suitable second material (mortar material) may therefore be a glass frit that exhibits suitable viscous flow during the firing cycle such that the enamel achieves maximum density and that pores are reduced to the lowest possible minimum. It should not crystallize too readily as that would hamper flow and could lead to unwanted cavities. The second material may therefore suitably be in the form of a milled glass frit. It is also noted that these frits generally have lower transition temperatures than the preferred ceramics or glass-ceramics for the first material, which makes them particularly useful as second material in the context of the present invention.

In a preferred embodiment glass frit of the second material may be a glass frit of the family of bismuth silicate, aluminoborosilicate, LAS and bismuth borate glasses or the second material comprises such a glass frit.

A suitable second material glass frit may comprise Bi₂O₃ in an amount of 25-50 wt. % and SiO₂ in an amount of 20-40 wt. %, preferably Bi₂O₃ in an amount of 30-45 wt. % and SiO₂ in an amount of 23-32 wt. %. Such a glass frit may further comprise B₂O₃ in an amount 2-20 wt. 8, such as 3-20 wt. %; Al₂O₃ in an amount of 2-20 wt. %; ZnO in an amount of 2-12 wt. %; alkaline oxides in an amount of >0-11 wt. % (including for instance Li₂O in an amount >0-8 wt. %; Na₂O in an amount of 0-3 wt. %) and further components to arrive at 100 wt. %. A preferred second material glass frit may comprise Bi₂O₃ in an amount of 30-45 wt. %; SiO₂ in an amount of 23-32 wt. %; B₂O₃ in an amount of 6-16 wt. %; Al₂O₃ in an amount of 4-18 wt. %; ZnO in an amount of 4-12 wt. % (such as 4-10 wt. %); alkaline oxides in an amount of >0-8 wt. % (including for instance Li₂O in an amount of 0.5-6 wt. %; and Na₂O in an amount of 0-2 wt. %) and optional further components to arrive at 100 wt. %.

The CTE of the enamel may further be adjusted by balancing the components based on their individual CTE and their volume fraction, wherein specific particle sizes are used to create a brick-and-mortar structure characterized by the first material phase being the bricks, and the second material phase being the mortar. Herein, the first material has a particle size D90 of >2× the particle size D90 of the second material.

The first and second materials can be selected according to a target firing temperature in the end application. The first and/or second materials may be chosen such that they provide a color to the fired coating or not (in the latter case the materials are non-pigment materials).

During firing the second material is required to soften and sinter to form a matrix which binds the particles of the first material and bonds the enamel coating to an underlying substrate forming a heterogenous bricks-and-mortar micro-structure. In addition to selecting the materials according to their transition temperature parameter, the materials may be processed such that the first material has a larger particle size than the second material to achieve a bricks-and-mortar micro-structure after firing. The specific particle sizes for the frits may vary according to the target micro-structure. To allow formation of such a microstructure, the first material has a first particle size D90 and the second material may have a second particle size D90; wherein the D90 of the first particles is more than 2 times the D90 of the second particles size. In a preferred embodiment the first material has a particle size D90 of >5× the particle size D90 of the second material. The particle size may alternatively or in addition be expressed as D50 particle size. In that case it is preferred that the first material has a particle size D50 of >4× the particle size D50 of the second material.

For example, the first material may have a particle size meeting one or more of the following characteristics: a D90: of at least 6 micron, 7 micron, 8 micron, 8.5 micron, or 8.8 micron; no more than 20 micron, 15 micron, 13 micron, 12.5 micron, or 11.8 micron; or within a range defined by any combination of the aforementioned lower and upper limits; 3.8 micron, or 3.6 micron; or within a range defined by any combination of the aforementioned lower and upper limits; a maximum particle size of no more than 40 micron, 35 micron, 30 micron, or 26 micron.

Furthermore, the second material may have a particle size meeting one or more of the following characteristics: a D90: of at least 0.5 micron, 0.8 micron, 1.0 micron, or 1.2 micron; or less than 20 micron, 17.5 micron, 15 micron, 13 micron, 10 micron, 7.5 micron, 6.5 micron, 6.35 micron, 5.9 micron, 4.4 micron, 4.25 micron, 4 micron, 3.5 micron, 3 micron, 2.2 micron, 1.9 or 1.8 micron; or within a range defined by any combination of the aforementioned lower and upper limits; a D50: of at least 0.1 micron, 0.2 micron, 0.3 micron, 0.4 micron, or 0.5 micron; no more than 1.4 micron, 1.3 micron, 1.2 micron, or 1.0 micron; or within a range defined by any combination of the aforementioned lower and upper limits; a maximum particle size of no more than 10 micron, 9 micron, 8 micron, 7 micron, or 6 micron. A very suitable exemplary D50 particle size is 1.4-1.7 micron.

For example, the first material may have: a D90 particle size in a range 8.5-12.5 micron, preferably 8.8-11.8 micron; a D50 particle size in a range of 1.5 to 5.5 micron, such as 5.2 micron, or in a range of 1.8-3.8 micron, preferably 1.9-3.6 micron; and a maximum particle size typically below 26 micron. The second material may have a D90 particle size in a range of 1.2-4 micron, such as 1.2-3.5 micron, such as 1.2-2.2 micron, such as 1.2-1.9 micron, for instance 3.3 micron; a D50 particle size in a range 0.5-1.2 micron, preferably 0.5-1.0 micron; and a maximum particle size typically below 6 micron.

It is to be understood that the above examples of D50 and D90 particle sizes and ranges may be chosen in any combination as long as the requirement that the first material has a particle size D90 of >2× the particle size D90 of the second material has been met.

The materials may be milled to the desired particle sizes in a suitable process that may comprise for example jet milling, dry or wet ball or bead milling, or a combination thereof. The medium used for wet milling processes may comprise water, alcohols, glycols, and may be mixed with a suitable addition of a dispersing agent. Wet milled powders are submitted to a suitable drying process, e.g. flame spray drying or tray drying, or are incorporated as a slurry in the final product (paste or ink) formulation. The particle size distributions are determined by a laser diffraction method and yield volume equivalent sphere diameters.

According to certain examples, the first material may form a larger volume and/or weight fraction and/or larger weight fraction enamel than the second material, or vice versa. This may be desirable when it is required that the functional parameters of the first material dominate the functional properties of the composite enamel after firing.

In light of the above, it will be appreciated that the type and amount of first and second glass frits can be tailored for a particular combination of desired functional performance characteristics.

In addition to the glass frit components, the composition may also include other additives, e.g. a seed additive, as is known in the art t to tune properties of glass/ceramic materials. Seed materials are used as nucleation agents and promote crystallization if that is necessary, typical seeds are bismuth silicate based or zinc silicate based. The weight ratio of the materials can be practically limited by the amount of functional additives, e.g. seed materials and pigments, that need to be embedded in the mortar or matrix phase containing the second material in the context of the invention which acts as an embedding matrix for functional additives. The respective amounts of functional additives depend on customer requirements and their process parameters and may vary according to their firing and bending process. This variation also affects the weight ratios of the frits and other components of the enamel paste.

The enamel paste may further comprise particles of a pigment, so that it effectively is in the form of an ink. Such pigments may include a mixed metal oxide pigment or a carbon black pigment. When used, such pigments may constitute no greater than about 55 wt. %, preferably 10-30 wt. % of the particle mixture, depending upon the range of color, gloss, and opacity desired in the enamel.

Suitable pigments may comprise complex metal oxide pigments, such as corundum-hematite, olivine, priderite, pyrochlore, rutile, and spinel. Other categories such as baddeleyite, borate, garnet, periclase, phenacite, phosphate, sphene and zircon may be suitable in certain applications.

Typical complex metal oxide pigments which may be used to produce black colors in the automotive industry include transition metal oxides having spinel-structure, such as spinel-structure oxides of copper, chromium, iron, cobalt, nickel, manganese, and the like. Although these black spinel pigments are preferred for use in the automotive industry, other metal oxide pigments to produce other various colours can be employed in the present invention.

Examples of commercially available pigments suitable for use in the present invention include copper manganese chromite pigments, copper chromite pigments, CuCr₂O₄, (Co,Fe)(Fe,Cr)₂O₄, (NiMnCrFe), and the like.

Mixtures of two or more pigments may also be employed in the particle mixture of the present invention.

Preferably, the D90 particle size of the particles of pigment is less than or equal to the D90 particle size of the particles of glass frit. More preferably, the D90 particle size of the particles of pigment is less than the D90 particle size of the particles of glass frit.

Using the pigments specified above exemplary coated substrate may have an enamel coating with a transmission in the UV-VIS-NIR spectrum of less than 0.01%.

The organic carrier medium which contains the first and second material and optional pigment and optional other additives may suitably comprise dispersants, solvents, and binder components. In accordance, an enamel paste or ink can be obtained by dispersing the inorganic particle components in an organic carrier medium comprising dispersants, solvents, and binder components, and which burns off during the firing process.

The enamel of the present invention is very suitable for coating low CTE substrate materials, although the enamel composition of the invention may also be used to coat substrates with higher CTE such as 6×10⁻⁶ K⁻¹ or more, including but not limited to standard glass substrates. The substrate in this respect may be an inorganic, non-metallic substrate selected from the group of glasses, preferably oxide glasses, ceramics, and glass-ceramics. Suitable examples may be substrates selected from but not limited to the group of soda-lime glass, borosilicate glass, aluminosilicate glass, lithium-alumina-silicon (LAS) glass ceramics, fused silica substrates and technical porcelain. The typical technical CTE of such substrates range below 6×10⁻⁶ K⁻¹.

In order to form an enamel coating the enamel paste composition is deposited on the substrate. Deposition may be performed by any suitable method known in the art, including but not limited to a deposition technique selected from the group of screen printing, digital printing, ink jet printing, curtain coating, spin coating, and slip casting. The particle sizes of the material used in the enamels of the inventions can be scaled to be suitable for a particular deposition technique, provided the size ratios of first and second materials meet the specifications in accordance with the invention.

After deposition the enamel can be dried and fired or fired without drying (wet firing).

The firing process softens the substrate which can be formed into the final shape by a bending process. Suitable exemplary firing conditions for the above specified enamels include firing takes place at a temperature between 600° C. and 700° C. for a duration between 3 and 15 minutes, for instance firing temperatures of: at least 600, 620, 635, or 650° C. and no more than 680, 690, or 700° C., and firing times of at least 3 minutes and no more than 15 minutes, preferably within less than 10 minutes, and even more preferably within less than 6 minutes.

After firing, the shape of the fired enamel substrate composite may be changed to obtain a desired coated article, for instance by sag bending or press-bending.

The enamel coated substrate according to the invention is in particular useful as a decorative article in automotive, marine, aerospace, home appliance, lab and table ware, architecture, and information technology. By way of an example, the enamel coated substrate is very suitable as automotive glazing, such as windshields, cover side windows, rear windows, quarter glass, sunroof glass, backlight glass and door glass.

### EXAMPLES

The invention will now be further described with reference to the following examples, which are illustrative, but not limiting the invention. In the Examples and Comparative Examples the materials as specified in tables 1, 2 and 3 were used. Exemplary pastes were applied as a paste by screen printing, depositing a wet layer with a thickness of 20 to 18 microns. The examples provide 100% of the inorganic composition.

TABLE 1
Oxide composition of brick materials

| | Oxide (wt. %) | | | |
|---|---|---|---|---|
| | | | | Brick |
| | Brick | Brick | Brick | material 9 |
| | material 1 | material 2, 3, 4 | Material 8 | (LAS glass |
| | (LAS ceramic) | (fused silica) | (LAS ceramic) | ceramic) |
| Bi₂O₃ | — | | — | 34.2 |
| SiO₂ | 68.1 | 100.0 | 64.6 | 27.7 |
| B₂O₃ | — | | — | 7.8 |
| Al₂O₃ | 26.5 | | 27.4 | 14.9 |
| ZnO | — | | — | 10.0 |
| Li₂O | 5.4 | | 8.0 | 4.7 |
| Na₂O | — | | — | 0.7 |

TABLE 2
Oxide composition of mortar materials.

Oxide (wt. %)

| | | | | Mortar |
|---|---|---|---|---|
| | Mortar | Mortar | Mortar | Materials |
| | Material 1 | Material 2 | Materials 3 | Range |
| Bi₂O₃ | 43.7 | 33.9 | 34.2 | 30-45 |
| SiO₂ | 30.2 | 25.5 | 27.7 | 23-33 |
| B₂O₃ | 14.5 | 7.7 | 7.8 | 6-16 |
| Al₂O₃ | 5.7 | 16.6 | 14.9 | 4-18 |
| ZnO | 4.9 | 9.7 | 10 | 4-12 |
| Li₂O | 0.9 | 5.2 | 4.7 | 0-8 |
| Na₂O | 0 | 1.4 | 0.7 | 0-5 |

TABLE 3
Oxide composition of frits in comparative examples.

Oxide

| | | | | Zinc |
|---|---|---|---|---|
| | | | Aluminosilicate | borosilicate |
| | | | frit | frit |
| | Frit 1 | Frit 2 | (Frit 5) | (Frit 6) |
| Bi₂O₃ | 60 | 60 | | |
| SiO₂ | 31.4 | 0.0 | 63.8 | 8.4 |
| B₂O₃ | 2.9 | 13.0 | | 31.6 |
| Al₂O₃ | 0.4 | | 22.3 | |
| ZnO | 1.5 | 15.0 | 3.6 | 60.0 |
| Li₂O | 1.5 | | 2.6 | |
| CuO | 0.3 | | | |
| MnO | 0.2 | | | |
| Fe₃O₄ | 0.1 | | | |
| Na₂O | 1.5 | | | |
| SnO₂ | | 12.0 | | |
| F | 0.2 | | | |
| MgO | | | 0.3 | |
| BaO | | | 2.6 | |
| CaO | | | 4.8 | |

The transition temperature, CTE and D90 particle size of these materials are listed in table 4 below. Herein, the CTE is the calculated CTE value before firing.

TABLE 4
transition temperature, CTE and D90
particle size of materials used.

| | Transition | | D90 |
|---|---|---|---|
| | temperature | CTE | particle |
| | (° C.) | (×10⁻⁷ K⁻¹) | size (μm) |
| Brick material 1 | 1840 | 3 | 10 |
| Brick material 2 | 1000-1200 | 5 | ~6 |
| Brick material 3 | 1000-1200 | 5 | ~18 |
| Brick material 4 | 1000-1200 | 5 | 11.6 |
| Brick material 8 | 1700-1900 | 11 | 9.6 |
| Brick material 9 | 500-630 | −14-0 | 8-12 |
| Mortar material 1 | 440 | 60 | 1.7 |
| Mortar material 2 | 489 | 80 | 3.6 |
| Mortar material 3 | 485 | 84 | 3.3 |
| Frit 1 | 454 | 78 | 11 |
| Frit 2 | 430 | 85 | 12 |
| Frit 5 | 500-600 | 15 | 9 |
| Frit 6 | 570 | 46 | 10 |
| Copper manganese | n.a. | 109 | 1.5-3.0 |
| chromite pigment | | | |
| Copper Chromite | n.a. | 110 | 1.5-2.5 |
| Pigment | | | |

Exemplary enamel pastes were prepared as listed in table 5 below. It is noted in this respect that Comparative example 1 is a commercially available composition comprising a first frit (Frit 1) having a transition temperature of 454° C., a CTE of 78×10⁻⁷ K⁻¹ and a D90 particle size of 13 micron, a second frit (frit 2) having a transition temperature of 430° C., a CTE of 85×10⁻⁷ K⁻¹ and a D90 particle size of 10.5 micron and a copper chromite pigment having a CTE of 110×10⁻⁷ K⁻¹ and a D90 particle size of 1.8 micron.

TABLE 5
compositions of exemplary enamels

| Example | Composition wt. % |
|---|---|
| Comparative | Frit 1, 30% |
| example 1 | Copper chromite pigment, 26%, |
| | Frit 2, 44% |
| Comparative | Frit 5, 15% |
| example 2 | Frit 6, 63%, |
| | Copper manganese chromite pigment, 22% |
| Example 1 | Brick material 4, 26.5% |
| | Mortar material 1, 48.2%, |
| | Copper manganese chromite pigment, 25.3% |
| Example 2 | Brick material 1, 36.5%, |
| | Mortar material 1, 41.6% |
| | Copper manganese chromite pigment, 22% |
| Example 3 | Brick material 1, 12%, |
| | Mortar material 2, 68% |
| | Copper manganese chromite pigment, 20% |
| Example 4 | Brick material 2, 26.5% |
| | Mortar material 1, 48.5% |
| | Copper manganese chromite pigment, 25% |
| Example 5 | Brick material 3, 26.5% |
| | Mortar material 1, 48.5% |
| | Copper manganese chromite pigment, 25% |
| Example 6 | Brick material 4, 24.6% |
| | Mortar material 1, 53.4% |
| | Copper manganese chromite pigment, 22.0%. |
| Example 7 | Brick material 4, 31.5% |
| | Mortar material 1, 68.5% |
| Example 8 | Mortar material 3, 62.8% |
| | Brick material 8, 23.2% |
| | Copper manganese chromite pigment, 14.0% |
| Example 9 | Mortar material 3, 60.4% |
| | Brick material 8, 25.6%, |
| | Copper manganese chromite pigment, 14.0% |
| Example 10 | Mortar material 3, 36.0%, |
| | Brick material 9, 50.0%, |
| | Copper manganese chromite pigment, 14.0% |

As a measure of the CTE matching of the enamels with the substrate a so-called Ring on Ring (ROR) Strength Test Procedure Test Method: EN1288-5 was performed. ROR is a mechanical bending stress measurement using Ring-on-Ring geometry, wherein the ROR values indicate the maximum stress leading to breakage of the enamel. A high ROR value indicates good CTE matching between the enamel and the substrate onto which it is fired.

For each test condition at least n. 15 samples (100 mm×100 mm annealed float glass squares (+/−2 mm in size) of the 3.8 mm nominal thickness) were fired at a given kiln set temperature. A Zwick (Universal mechanical test machine) equipped with load cell better than 2% accuracy within a range of 100N to 5000N having a capability of load control to achieve a stressing rate of 2 MPa/s+/−0.4 MPa/s was used. Further, a Ring-on-Ring tool R30 with silicone rubber rings hardness 30-50 IRHD according EN 1288-5 (size of rings, tool surface finish) was used. The structure, color and opacity were also analyzed.

### Examples 1-3 and 8-10 vs Comparative Examples

Table 6 shows the results of a number of exemplary enamels and comparative examples fired onto borosilicate glass.

TABLE 6
ROR dependency on frit composition.

| | Brick- | | Firing | | | |
|---|---|---|---|---|---|---|
| | and- | | Set | Color | Opacity | ROR |
| | mortar | | Temperature | (L- | (Optical | (s50) |
| | structure | Visual | [° C.] | value) | Density) | [Mpa] |
| COMPARATIVE | NO | Severe | 700 | NA | NA | NA |
| EXAMPLE 1 | | Micro- | | | | |
| | | cracks | | | | |
| COMPARATIVE | NO | Micro- | 700 | 4.2 | 2.9 | 11.0 |
| EXAMPLE 2 | | cracks | | | | |
| EXAMPLE 1 | YES | OK | 700 | 4.4 | 2.6 | 26.53 (113 |
| | | | | | | undecorated) |
| EXAMPLE 2 | YES | OK | 700 | 5.2 | 2.0 | 31.0 |
| EXAMPLE 3 | YES | OK | 630 | 5.5 | 2.3 | 34.3 |
| EXAMPLE 8 | YES | OK | 630 | 6.3 | 1.7 | 45.6 |
| EXAMPLE 9 | YES | OK | 630 | 8.6 | 2.0 | 62.3 |
| EXAMPLE 10 | YES | OK | 600 | 5.0 | 2.0 | 48.0 |

The calculated CTE of Comparative Example 1 before firing was 89×10⁻⁷ K⁻¹. The calculated CTE of Comparative example 2 before firing was 49.3×10⁻⁷ K⁻¹. The calculated CTE of Example 1 before firing was 45×10⁻⁷ K⁻¹. The calculated CTE of Example 2 before firing was 40×10⁻⁷ K⁻¹. The calculated CTE of Example 3 before firing was 70×10⁻⁷ K⁻¹.

It is noted that during firing the mortar phase of the examples 1-3 and 8-10 crystallizes partially, effectively decreasing CTE, so that after firing the fired enamel of has a much lower enamel CTE. The comparative examples, in the absence of such a mortar phase, do not show such a decrease in CTE so that examples 1-3 have a lower enamel CTE after firing. This is further evidenced by the fact that table 6 shows that a higher ROR value can be achieved with examples 1 to 3 and 8-10 according to the invention than with the comparative examples.

### Examples 4 and 5

The effect of varying sizes of first material (brick material) was used by testing two different commercial low CTE glass fillers with sizes D90 of ~6 μm and D90 of ~18 μm (Examples 4 and 5, respectively) on borosilicate glass. The results are shown in Table 7.

TABLE 7
Table B: ROR dependency on Brick particle size.

| | Brick- | | | | | |
|---|---|---|---|---|---|---|
| | and- | | Firing Set | Colour | Opacity | ROR |
| | mortar | | Temperature | (L- | (Optical | (s50) |
| | structure | Visual | [° C.] | value) | Density) | [Mpa] |
| EXAMPLE 4 | YES | OK | 700 | 6.0 | 2.0 | 26.0 |
| EXAMPLE 5 | YES | OK | 700 | 5.5 | 1.9 | 14.0 |

Table 7 shows that the ROR values can be controlled by tuning the particle size of first (brick) material.

### Examples 6 and 7

The effect of the presence of pigment tested with two different enamel pastes on borosilicate glass, with pigment copper manganese chromite pigment (Example 6) and without pigment (Example 7). The results are shown in Table 6.

TABLE 8
ROR dependency with and without pigment.

| | Brick- | | | | | |
|---|---|---|---|---|---|---|
| | and- | | Firing Set | Colour | Opacity | ROR |
| | mortar | | Temperature | (L- | (Optical | (s50) |
| | structure | Visual | [° C.] | value) | Density) | [Mpa] |
| EXAMPLE 6 | YES | OK | 700 | 6.8 | 2.9 | 24.5 |
| EXAMPLE 7 | YES | OK | 700 | NA | NA | 44.1 |
| (no | | (white) | | | | |
| pigment) | | | | | | |

Table 6 shows that the total enamel CTE, hence ROR, varies with the pigment amount.

### Example 1 Tested in on Different Substrates

The effect of the substrate was tested with the enamel paste of Example 1 on two different commercially available borosilicate glasses (borosilicate glass 1 with a CTE of 38×10⁻⁷ K⁻¹ and borosilicate glass 2 with a CTE of 38×10⁻⁷ K⁻¹) and on commercially available sodalime glass with a CTE of 80×10⁻⁷ K⁻¹, and without pigment. The results are shown in Table 9.

TABLE 9
ROR dependency on substrate materials.

| | Brick- | | | | | |
|---|---|---|---|---|---|---|
| | and- | | Firing Set | Colour | Opacity | ROR |
| | mortar | | Temperature | (L- | (Optical | (s50) |
| | structure | Visual | [° C.] | value) | Density) | [Mpa] |
| EXAMPLE 1 | YES | OK | 700 | 4.4 | 2.6 | 26.5 (113 |
| on borosilicate | | | | | | undecorated) |
| glass 1 | | | | | | |
| EXAMPLE 1 | YES | OK | 700 | 4.1 | 2.7 | 59.7 (96 |
| on borosilicate | | | | | | undecorated) |
| glass 2 | | | | | | |
| EXAMPLE 1 | YES | OK | 680 | 4.3 | 2.9 | 168 (200 |
| on sodalime | | | | | | undecorated) |
| glass | | | | | | |

Table 9 shows that the bending strength varies depending on the glass substrates used.

1. An enamel paste comprising:
a first material selected from particles of glass, ceramic or glass-ceramic particles;
a second material selected from particles of glass, ceramic or glass-ceramic particles; and
an organic carrier medium;
wherein the first material has a first coefficient of thermal expansion (CTE1), a first particle size D90 and a first transition temperature (T1) and wherein said second material has a second coefficient of thermal expansion (CTE2), a second particle size D90 and a second transition temperature (T2); wherein
CTE1<CTE2; and
T1>T2; and
wherein the first material has a particle size D90 of >2× the particle size D90 of the second material.

2. The enamel paste according to claim 1, wherein CTE1<8×10⁻⁶ K⁻¹, wherein the value of CTE1 relates to the CTE value before firing.

3. The enamel paste according to claim 2, wherein CTE1 is between −3 and 4.5×10₋₆ K−1, wherein the value of CTE1 relates to the CTE value before firing.

4. The enamel paste according to claim 2, wherein CTE1 is a negative CTE, wherein the value of CTE1 re-lates to the CTE value before firing.

5. The enamel paste according to claim 1, wherein CTE2<10×10⁻⁶ K⁻¹, wherein the value of CTE2 relates to the CTE value before firing.

6. The enamel paste according to claim 5, wherein CTE2 is between 6 and 9×10⁻⁶ K⁻¹, wherein the value of CTE2 relates to the CTE value before firing.

7. The enamel paste according to claim 1, wherein the first material is a ceramic material and T1>800° C., or wherein T1>900° C., or wherein T1>1000° C.

8. The enamel paste according to claim 1, wherein the first material comprises >30 wt. % SiO₂, preferably >40 wt. % SiO₂, such as >50 wt. % SiO₂, or >60 wt. % SiO₂.

9. The enamel paste according to claim 1, wherein the first material is selected from the group of an oxide material, aluminosilicate, fused silica, glass ceramics from the LAS-system including β-eucryptite glass ceramics, β-spodumene solid solution ceramics, ceramic components of the pseudo-brookite type, cordierite, perovskite type material, magnesium pyrophosphate, low CTE glass frit, or a mixture thereof.

10. The enamel paste according to claim 1, wherein the first material is a glass-ceramic comprising 4.0-6 wt. % Li₂O, 13-19 wt. % Al₂O₃, 25-42 wt. % SiO₂ and having a CTE1 before firing selected from the group consisting of between −3 to 2×10⁻⁶ K⁻¹, preferably between −2.0 to 1.5×10⁻⁶ K⁻¹, and between −1.5 to 1.0×10⁻⁶ K⁻¹ in the temperature range between 25-300° C.

11. The enamel paste according to claim 1, wherein the second material is a milled glass frit.

12. The enamel paste according to claim 11, wherein said glass frit is a glass frit of the family of bismuth silicate, aluminoborosilicate, LAS, and bismuth borate glasses or wherein the second material comprises such a material.

13. The enamel paste according to claim 1, wherein the second material is a glass frit comprising
Bi₂O₃ in an amount of 25-50 wt. %;
SiO₂ in an amount of 20-40 wt. %.

14. The enamel paste according to claim 13, wherein the second material further comprises
B₂O₃ in an amount of 2-20 wt. %;
Al₂O₃ in an amount of 2-20 wt. %;
ZnO in an amount of 2-12 wt. %;
alkaline oxides in an amount of >0-11 wt. %.

15. The enamel paste according to claim 14, wherein the second material comprises
Bi₂O₃ in an amount of 30-45 wt. %;
SiO₂ in an amount of 23-32 wt. %;
B₂O₃ in an amount of 6-16 wt. %;
Al₂O₃ in an amount of 4-18 wt. %;
ZnO in an amount of 4-12 wt. %;
alkaline oxides in an amount of >0-8 wt. %.

16. The enamel paste according to claim 1, further comprising a pigment.

17. The enamel paste according to claim 16, wherein the pigment content ranges between 12-55 wt % of the enamel paste, such as between 12-30 wt. %.

18. The enamel paste according to claim 1, further comprising a nucleation agent.

19. The enamel paste according to claim 1, wherein the organic carrier medium comprises dispersants, solvents, and binder components.

20. A method of forming an enamel coating, comprising
i) depositing the enamel paste composition according to claim 1 on a substrate with a third coefficient of thermal expansion (CTE3); and
ii) firing the enamel paste to form an enamel coating on the substrate, the enamel coating comprising a heterogeneous microstructure with particles of the first material embedded in a matrix comprising said second material; and
wherein after depositing and firing the enamel has a composite coefficient of thermal expansion (CTE-COMP), wherein CTE-COMP≤CTE3.

21. The method according to claim 20, wherein CTE1<CTE3.

22. The method according to claim 20, wherein depositing takes place by a deposition technique selected from the group consisting of screen printing, digital printing, ink jet printing, curtain coating, spin coating, and slip casting.

23. The method according to claim 20, wherein firing takes place at a temperature between 600° C. and 700° C. for a duration between 3 and 15 minutes.

24. The method according to claim 20, wherein CTE3<6×10⁻⁶ K⁻¹, typically between 2 and 6× 10⁻⁶ K⁻¹.

25. The method according to claim 20, wherein the substrate is an inorganic, non-metallic substrate selected from the group of glasses, preferably oxide glasses, ceramics, and glass-ceramics.

26. The method according to claim 25, wherein the substrate is selected from the group consisting of soda-lime glass, borosilicate glass, aluminosilicate glass, lithium-alumina-silicon (LAS) glass ceramics, fused silica substrates and technical porcelain.

27. The method according to claim 20, wherein the shape of the fired enamel substrate composite is changed, for instance by sag bending or press-bending.

28. An enamel coated substrate obtainable or obtained by the method of claim 20.

29. The enamel coated substrate according to claim 28, wherein the enamel coating has a transmission in the UV-VIS-NIR spectrum of less than 0.01%.

30. The enamel coated substrate according to claim 28 as a decorative and/or functional article in automotive, marine, aerospace, home appliance, lab and table ware, pharmaceutical pack-aging, architecture, and information technology.
